(19) United States
(12) Patent Application Publication
(10) Pub. No.: US 2019/0284942 A1
(43) Pub. Date: Sep. 19, 2019

(54) METHOD OF REPAIRING CERAMIC COATING, CERAMIC COATING, TURBINE MEMBER, AND GAS TURBINE

(71) Applicant: MITSUBISHI HEAVY INDUSTRIES, LTD., Tokyo (JP)

(72) Inventors: Shuji Tanigawa, Tokyo (JP); Masahiko Mega, Tokyo (JP); Taiji Torigoe, Tokyo (JP); Yoshifumi Okajima, Tokyo (JP); Daisuke Kudo, Tokyo (JP); Shuho Tsubota, Tokyo (JP)

(73) Assignee: MITSUBISHI HEAVY INDUSTRIES, LTD., Tokyo (JP)

(21) Appl. No.: 16/285,699

(22) Filed: Feb. 26, 2019

(30) Foreign Application Priority Data
Mar. 13, 2018 (JP) 2018-045419

(51) Int. Cl. F01D 5/28; C23C 4/01; C23C 4/18; C23C 24/08

(52) U.S. Cl. CPC F01D 5/288; C23C 4/01; F05B 2230/90; C23C 24/08; F05B 2230/80; C23C 4/18

(57) ABSTRACT

A method of repairing a ceramic coating according to an embodiment includes forming a second ceramic layer by thermally spraying ceramic spray particles to a repair section of the ceramic coating in which a first ceramic layer is formed, and melting a part of an interface, on a surface side of the ceramic coating, between the first ceramic layer and the second ceramic layer by heating the part.

### TECHNICAL FIELD

The present disclosure relates to a method of repairing a ceramic coating, a ceramic coating, a turbine member, and a gas turbine.

### BACKGROUND ART

A power generation device such as a gas turbine is used in a high-temperature environment. Thus, stator blades and rotor blades, a wall material of a combustor, and the like of the gas turbine are formed from heat-resistant members. Further, thermal barrier coating (TBC) is formed on base members made from the heat-resistant members to protect the heat-resistant members from a high temperature.

As described above, a ceramic coating may be formed on the base members in order to protect the base members.

In a case in which such a ceramic coating is partially damaged, if the entire ceramic coating is separated from the base members, and a new a ceramic coating is formed, it takes a lot of time and cost to repair the ceramic coating. Therefore, the ceramic coating should be partially repaired.

For example, Patent Document 1 discloses a method of partially repairing a damaged part of the TBC by thermally spraying ceramic particles to the damaged part.

### CITATION LIST

### Patent Literature

Patent Document 1: JP5909274B

### SUMMARY

The method of partially repairing the ceramic coating disclosed in Patent Document 1 includes irradiating a laser to a repair portion (repair coating) formed by thermally spraying the ceramic particles to the damaged part of the TBC and forming a vertical crack by a sharp temperature difference made in the repair portion. As described above, in the method of partially repairing the ceramic coating disclosed in Patent Document 1, the vertical crack is formed in the repair coating in order to improve heat cycle durability of the repair coating and to improve an anti-separation property of the repair coating. In the method disclosed in Patent Document 1, however, adhesiveness at an interface between the repair coating and a healthy ceramic layer around the repair coating may be insufficient.

In view of the above, an object of at least one embodiment of the present invention is to improve durability of a ceramic coating.

(1) A method of repairing a ceramic coating according to at least one embodiment of the present invention includes forming a second ceramic layer by thermally spraying ceramic spray particles to a repair section of the ceramic coating in which a first ceramic layer is formed, and melting a part of an interface, on a surface side of the ceramic coating, between the first ceramic layer and the second ceramic layer by heating the part.

As a result of intensive researches by the present inventors, it was found that adhesiveness between the first ceramic layer and the second ceramic layer can be improved while maintaining heat cycle durability, a thermal conductivity, and anti-erosion performance of the second ceramic layer equal to those of the first ceramic layer by melting the part of the above-described interface, on the surface side of the ceramic coating, by heating the part.

Therefore, according to the above method (1), since the adhesiveness between the first ceramic layer and the second ceramic layer can be improved while maintaining the heat cycle durability, the thermal conductivity, and the anti-erosion performance of the second ceramic layer equal to those of the first ceramic layer, durability of a repair portion of the ceramic coating is improved, making it possible to improve durability of the ceramic coating.

(2) In some embodiments, in the above method (1), in the melting of the portion, a superficial portion of the second ceramic layer is heated and melted in addition to the part of the interface.

A portion which is heated, melted, and then solidified in the ceramic coating has a hardness higher than that of an unheated and unmelted portion. In this regard, according to the above method (2), since the hardness of the superficial portion of the second ceramic layer after being heated and melted is high compared to a case in which the portion is neither heated nor melted, it is possible to improve the anti-erosion performance of the second ceramic layer.

Therefore, if the repair section needs repairing owing to erosion, the above method (2) can improve the durability of the ceramic coating after repair.

(3) In some embodiments, in the above method (1) or (2), the second ceramic layer has a higher porosity rate than the first ceramic layer.

In general, in the ceramic coating, a thermal conductivity decreases as a porosity rate increases. Therefore, according to the above method (3), it is possible to make the thermal conductivity of the second ceramic layer lower than that of the first ceramic layer. Therefore, for example, if the repair section needs an improvement of thermal barrier performance upon being repaired, the above method (3) can improve the thermal barrier performance.

(4) In some embodiments, in any one of the above methods (1) to (3), in the forming of the second ceramic layer, the second ceramic layer is formed to have a porosity rate of 10% or more and 30% or less.

For instance, when the first ceramic layer is formed by thermal spray or the like, a general lower limit value of the porosity rate of the first ceramic layer is about several %.

Thus, if the second ceramic layer is formed to have the porosity rate of 10% or more, it is possible to expect that the thermal conductivity of the second ceramic layer becomes lower than that of the first ceramic layer. Therefore, for example, if the improvement of the thermal barrier performance is required because the repair section is in a severer temperature environment than a region other than the repair section, it is possible to expect that the above method (4) improves the thermal barrier performance of the second ceramic layer after repair as compared with before repair.

On the other hand, if the porosity rate of the second ceramic layer increases, the adhesiveness with the first ceramic layer tends to decrease. Thus, if the porosity rate of the second ceramic layer exceeds 30%, the adhesiveness with the first ceramic layer may be insufficient.

In this regard, according to the above method (4), it is possible to ensure the thermal barrier performance of the second ceramic layer while ensuring the adhesiveness with the first ceramic layer.

(5) In some embodiments, in any one of the above methods (1) to (4), in the melting of the part, any one of a laser, an electronic beam, or a plasma is irradiated to selectively heat and melt a superficial region of the ceramic coating including the part of the interface.

According to the above method (5), it is possible to selectively heat and melt the region to be melted, and to suppress thermal damage to another region.

(6) In some embodiments, in any one of the above methods (1) to (5), in the forming of the second ceramic layer, the second ceramic layer is formed adjacent to the first ceramic layer in an in-plane direction of the first ceramic layer.

According to the above method (6), since the adhesiveness between the first ceramic layer and the second ceramic layer adjacent to the first ceramic layer in the in-plane direction can be improved while maintaining the heat cycle durability, the thermal conductivity, and the anti-erosion performance of the second ceramic layer equal to those of the first ceramic layer, the durability of the repair portion of the ceramic coating is improved, making it possible to improve the durability of the ceramic coating.

(7) In some embodiments, in any one of the above methods (1) to (6), in the forming of the second ceramic layer, the second ceramic layer is formed with the interface extending in a direction inclined with respect to a thickness direction of the first ceramic layer.

According to the above method (7), the above-described interface may extend in the direction inclined with respect to the thickness direction of the first ceramic layer.

(8) In some embodiments, in any one of the above methods (1) to (7), in the forming of the second ceramic layer, the second ceramic layer is formed by thermally spraying the ceramic spray particles of the same material as a material of the first ceramic layer to the repair section.

According to the above method (8), since the first ceramic layer and the second ceramic layer are made of the same material, the first ceramic layer and the second ceramic layer also have the same linear expansion coefficient, improving durability against a thermal history.

(9) In some embodiments, in any one of the above methods (1) to (8), the first ceramic layer is formed by thermal spray, and in the forming of the second ceramic layer, the second ceramic layer is formed by thermally spraying the ceramic spray particles to the repair section on the same spray condition as a spray condition upon formation of the first ceramic layer.

According to the above method (9), it is possible to make the porosity rate, the thermal conductivity, the anti-erosion performance, and the like of the first ceramic layer equal to those of the second ceramic layer.

(10) In some embodiments, in any one of the above methods (1) to (9), the method of repairing the ceramic coating further includes treating a surface of the repair section.

According to the above method (10), it is possible to ensure the adhesiveness between the first ceramic layer and the second ceramic layer by treating the surface of the repair section.

(11) In some embodiments, in any one of the above methods (1) to (10), the method of repairing the ceramic coating further includes removing an overfill portion of the second ceramic layer formed in the forming of the second ceramic layer.

According to the above method (11), it is possible to suppress defective melting of the part on the surface side of the ceramic coating by removing the overfill portion before heating and melting the part. Thus, it possible to ensure the adhesiveness between the first ceramic layer and the second ceramic layer.

(12) In some embodiments, in any one of the above methods (1) to (11), the method of repairing the ceramic coating further includes smoothing a surface of a molten-and-solidified portion formed in the melting of the portion.

According to the above method (12), the surface of the second ceramic layer is smoothed.

(13) A ceramic coating according to at least one embodiment of the present invention includes a first ceramic layer, a second ceramic layer adjacent to the first ceramic layer in an in-plane direction of the first ceramic layer, and a molten-and-solidified portion obtained by melting and solidifying at least a part of an interface, on a surface side of the first ceramic layer, between the first ceramic layer and the second ceramic layer.

As a result of intensive researches by the present inventors, it was found that the adhesiveness between the first ceramic layer and the second ceramic layer can be improved while maintaining the heat cycle durability, the thermal conductivity, and the anti-erosion performance of the second ceramic layer equal to those of the first ceramic layer by forming the molten-and-solidified portion in the part of the above-described interface on the surface side of the first ceramic layer.

Therefore, according to the above configuration (13), since the adhesiveness between the first ceramic layer and the second ceramic layer can be improved while maintaining the heat cycle durability, the thermal conductivity, and the anti-erosion performance of the second ceramic layer equal to those of the first ceramic layer, the durability of the ceramic coating can be improved.

(14) In some embodiments, in the above configuration (13), the molten-and-solidified portion has a depth of 5 micrometers or more and 100 micrometers or less.

If the depth of the molten-and-solidified portion is less than 5 micrometers, owing to a depth variation upon formation of the molten-and-solidified portion, the depth may become extremely shallow in a particular region, generating a portion where the adhesiveness between the first ceramic layer and the second ceramic layer is insufficient. Thus, it is desirable that the depth of the molten-and-solidified portion is 5 micrometers or more. Further, if the depth of the molten-and-solidified portion exceeds 100 μm, the heat cycle durability of the molten-and-solidified portion may decrease. Thus, it is desirable that the depth of the molten-and-solidified portion is 100 μm or less.

In this regard, with the above configuration (14), since the depth of the molten-and-solidified portion is 5 micrometers or more and 100 micrometers or less, it is possible to endure the heat cycle durability of the molten-and-solidified portion while ensuring the adhesiveness between the first ceramic layer and the second ceramic layer.

(15) In some embodiments, in the above configuration (13) or (14), the molten-and-solidified portion has a width of 1 mm or more.

If the width of the molten-and-solidified portion is less than 1 mm, owing to a positional variation in part heated and melted upon formation of the molten-and-solidified portion, an unheated and unmelted place may be generated in the part of the above-described interface on the surface side of the first ceramic layer. In particular, the above-described interface does not always extend in a direction orthogonal to the surface of the first ceramic layer but may extend diagonally with respect to the surface of the first ceramic layer. Therefore, if the width of the molten-and-solidified portion is less than 1 mm, a portion except for a very shallow portion of the interface on the surface side of the first ceramic layer may fall out of a heating-and-melting range upon formation of the molten-and-solidified portion, making it impossible to heat and melt the interface to a desired depth.

As described above, if the width of the molten-and-solidified portion is less than 1 mm, the portion where the adhesiveness between the first ceramic layer and the second ceramic layer is insufficient may be generated. Thus, it is desirable that the width of the molten-and-solidified portion is 1 mm or more.

In this regard, according to the above configuration (15), since the width of the molten-and-solidified portion is 1 mm or more, it is possible to ensure the adhesiveness between the first ceramic layer and the second ceramic layer.

(16) In some embodiments, in the above configuration (13) or (14), the molten-and-solidified portion is in a state where, a superficial portion of the second ceramic layer is melted and solidified in addition to the part of the interface.

The molten-and-solidified portion has a hardness higher than that of an unheated and unmelted portion. In this regard, according to the above configuration (16), since the hardness of the superficial portion of the second ceramic layer is high compared to a case in which the superficial portion is neither heated nor melted, it is possible to improve the anti-erosion performance of the second ceramic layer.

(17) In some embodiments, in any one of the above configurations (13) to (16), the second ceramic layer has a porosity rate of 10% or more and 30% or less.

Setting the porosity rate of the second ceramic layer at 10% or more as described above, it is possible to expect that the thermal conductivity of the second ceramic layer becomes lower than that of the first ceramic layer. Therefore, with the above configuration (17), it is possible to expect that the thermal barrier performance of the second ceramic layer improves compared to that of the first ceramic layer.

On the other hand, if the porosity rate of the second ceramic layer exceeds 30% as described above, the adhesiveness with the first ceramic layer may be insufficient.

In this regard, according to the above configuration (17), it is possible to ensure the thermal barrier performance of the second ceramic layer while ensuring the adhesiveness with the first ceramic layer.

(18) A turbine member according to at least one embodiment of the present invention includes the ceramic coating according to any one of the above configurations (13) to (17).

According to the above configuration (18), since the adhesiveness between the first ceramic layer and the second ceramic layer can be improved while maintaining the heat cycle durability, the thermal conductivity, and the anti-erosion performance of the second ceramic layer equal to those of the first ceramic layer, durability of the turbine member can be improved.

(19) A gas turbine according to at least one embodiment of the present invention includes the turbine member according to the above configuration (18).

According to the above configuration (19), it is possible to improve the durability of the turbine member in the gas turbine.

According to at least one embodiment of the present invention, it is possible to improve the durability of the ceramic coating.

### BRIEF DESCRIPTION OF DRAWINGS

FIG. 1 is a schematic cross-sectional view of a turbine member including a ceramic coating according to an embodiment.

FIG. 2 is a cross-sectional view schematically showing a state in which a ceramic layer is partially damaged.

FIG. 3 is a flowchart showing a procedure for a method of repairing the ceramic coating according to some embodiments.

FIG. 4 is a schematic cross-sectional view of the ceramic coating after treating a surface of a repair section in a pre-processing step.

FIG. 5 is a schematic cross-sectional view of the ceramic coating after forming a repair layer in a repair layer forming step.

FIG. 6 is a schematic cross-sectional view of the ceramic coating after removing an overfill portion of the repair layer in an overfill portion removing step.

FIG. 7 is a schematic cross-sectional view of the ceramic coating which includes a molten-and-solidified portion formed by heating, melting, and then solidifying a part of an interface, on a surface side of the ceramic coating, between the ceramic layer and the repair layer.

FIG. 8 is a schematic cross-sectional view of the ceramic coating which includes a molten-and-solidified portion formed by heating, melting, and then solidifying a superficial portion of the repair layer in addition to the part of the interface on the surface side.

FIG. 9 is a perspective view of a configuration example of a gas turbine rotor blade.

FIG. 10 is a perspective view of a configuration example of a gas turbine stator vane.

FIG. 11 is a schematic diagram of a partial cross-sectional structure of a gas turbine according to an embodiment.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved. On the other hand, an expression such as “comprise”, “include”, “have”, “contain” and “constitute” are not intended to be exclusive of other components.

(Ceramic Coating)

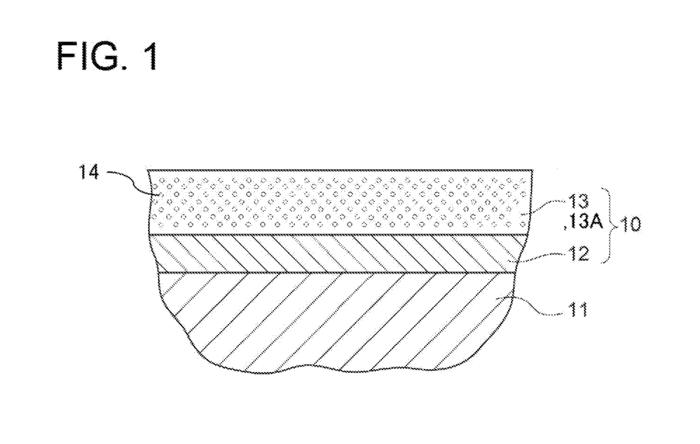

FIG. 1 is a schematic cross-sectional view of a turbine member including a ceramic coating according to an embodiment. In some embodiments described below, as an example of the ceramic coating, thermal barrier coating for thermal barrier of a turbine member will be described.

In some embodiments, on a heat-resistant base member (base material) 11 such as a rotor blade and a stator vane of a turbine, a metallic bond layer (bond coat layer) 12 and a ceramic layer 13 are formed in order as thermal barrier coating. That is, as depicted in FIG. 1, in some embodiments, a ceramic coating 10 is a thermal barrier coating (TBC) layer, and includes the bond coat layer 12 and the ceramic layer 13.

The bond coat layer 12 is formed of MCrAlY alloy (M indicates a metallic element such as Ni, Co, and Fe, or a combination of two or more from the above metallic elements).

The ceramic layer 13 in some embodiments is formed of any one of YbSZ (ytterbia-stabilized zirconia), YSZ (yttria-stabilized zirconia), SmYbZr₂O₇, DySZ (dysprosia-stabilized zirconia), ErSZ (erbia-stabilized zirconia), or the like.

In some embodiments, the ceramic layer 13 is formed as a porous structure including pores 14 to ensure thermal barrier performance. The pores 14 in FIG. 1 and respective views to be described later schematically show the pores 14 in the ceramic layer 13, and are different from actual pores in size, shape, and density. A porosity rate and a thickness of the ceramic layer 13 are set appropriately in accordance with a required thermal conductivity. In some embodiments, the porosity rate of the ceramic layer 13 is, for example, 3% or more and 20% or less.

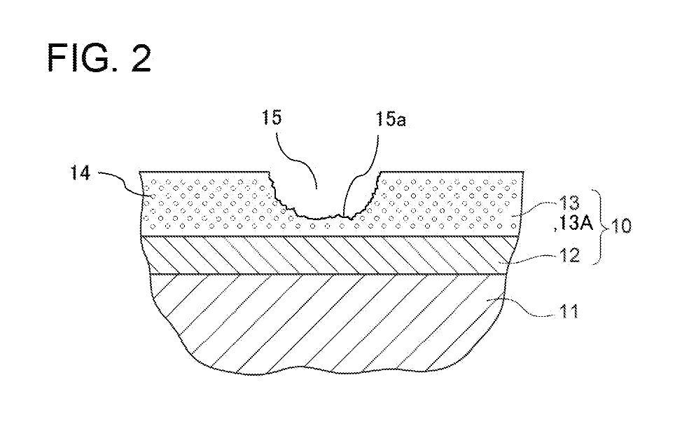

If a member where the ceramic coating 10 according to some embodiments is formed, that is, the turbine member or the like is used, the ceramic layer 13 may partially be damaged due to erosion, a collision of flying objects, or the like. FIG. 2 is a cross-sectional view schematically showing a state in which the ceramic layer 13 is partially damaged. In a case in which the ceramic coating 10 is partially damaged as described above, if the entire ceramic coating 10 is separated from the base material 11, and the new ceramic coating 10 is formed, it takes a lot of time and cost to repair the ceramic coating 10. Therefore, the ceramic coating 10 should be partially repaired.

In partially repairing the ceramic coating 10, it is necessary to ensure adhesiveness between an undamaged healthy portion of the ceramic coating 10 and a portion newly formed by repair.

To achieve this, in some embodiments described below, the ceramic coating is repaired to be able to ensure the adhesiveness between the undamaged healthy portion of the ceramic coating 10 and the portion newly formed by repair.

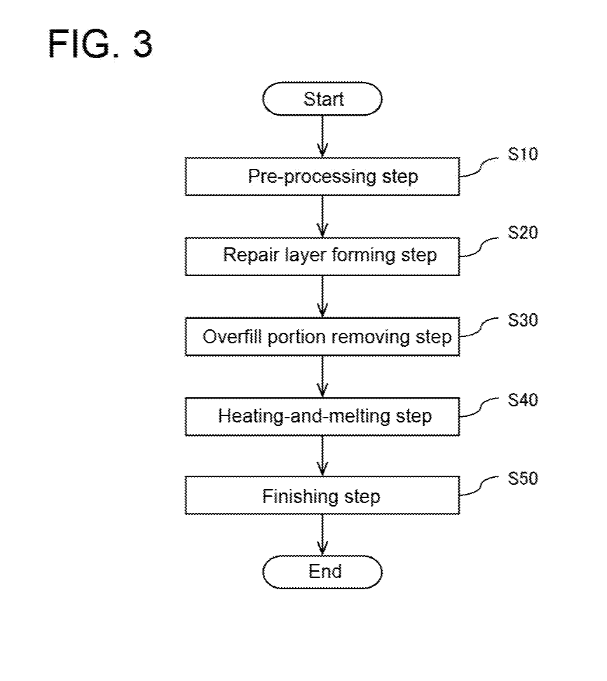

FIG. 3 is a flowchart showing a procedure for a method of repairing the ceramic coating according to some embodiments.

The method of repairing the ceramic coating according to some embodiments includes a pre-processing step S10, a repair layer forming step S20, an overfill portion removing step

S30, a heating-and-melting step S40, and a finishing step S50.

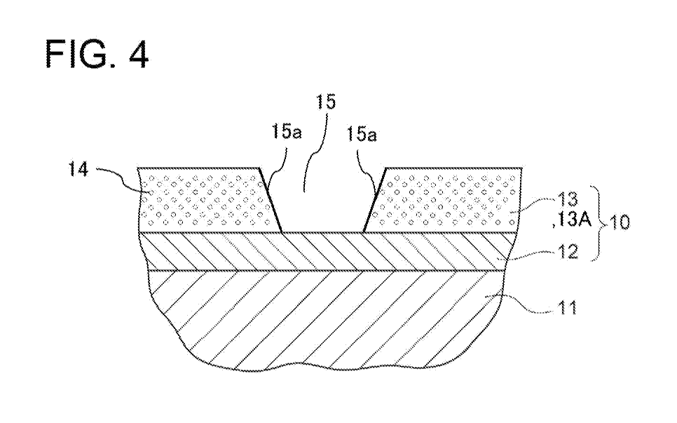

The pre-processing step S10 is a step of treating a surface where a repair layer is formed in the repair layer forming step S20 to be performed later by performing blasting or the like on a repair section 15 which is a damaged part of the ceramic coating 10. FIG. 4 is a schematic cross-sectional view of the ceramic coating 10 after treating a surface 15a of the repair section 15 in the pre-processing step S10.

The repair layer forming step S20 is a step of forming a repair layer 16 in the repair section 15 of the ceramic coating 10. In some embodiments, in the repair layer forming step S20, the repair layer 16 is formed by, for example, thermally spraying ceramic spray particles to the repair section 15 of the ceramic coating 10.

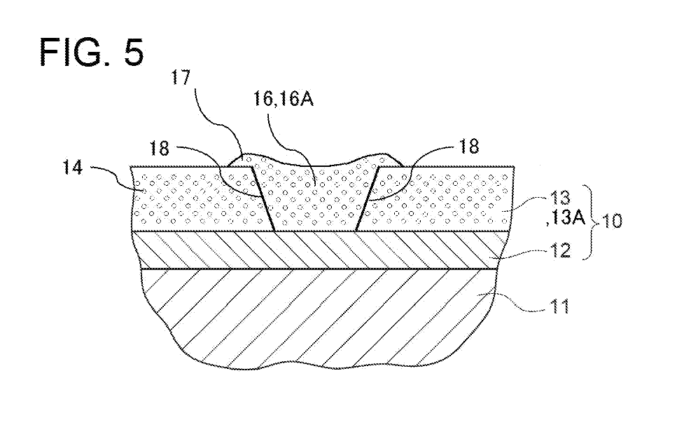

In some embodiments, in the repair layer forming step S20, the repair layer 16 is formed by thermally spraying ceramic spray particles of the same material as the ceramic layer 13 to the repair section 15 of the ceramic coating 10. FIG. 5 is a schematic cross-sectional view of the ceramic coating 10 after forming the repair layer 16 in the repair layer forming step S20. In the description below, the ceramic layer 13 is also referred to as a first ceramic layer 13A, and the repair layer 16 is also referred to as a second ceramic layer 16A. That is, the repair layer forming step S20 is a step of forming the second ceramic layer 16A by thermally spraying the ceramic spray particles to the repair section 15 of the ceramic coating 10 in which the first ceramic layer 13A is formed.

If the ceramic layer 13 is formed by thermal spray, a spray condition such as a spray distance upon formation of the repair layer 16 may be the same as a spray condition upon formation of the ceramic layer 13. The ceramic layer 13 and the repair layer 16 can have an equal porosity rate, thermal conductivity, anti-erosion performance, and the like by making the spray condition upon formation of the repair layer 16 the same as the spray condition upon formation of the ceramic layer 13 and forming the repair layer 16 with the same spray particles as spray particles used to form the ceramic layer 13.

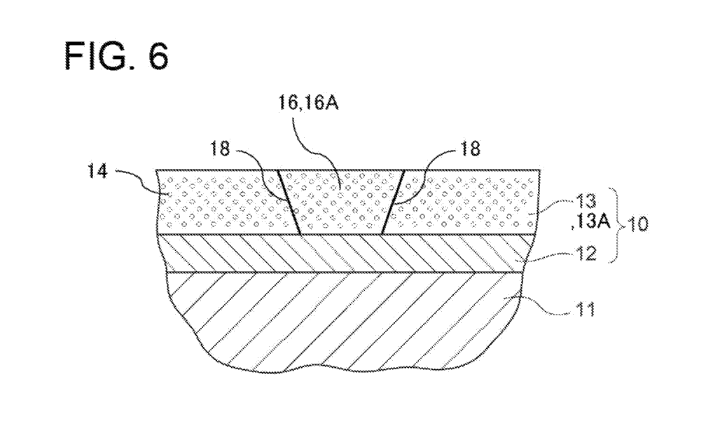

The overfill portion removing step S30 is a step of removing an overfill portion 17 of the repair layer 16 formed in the repair layer forming step S20. FIG. 6 is a schematic cross-sectional view of the ceramic coating 10 after removing the overfill portion 17 (see FIG. 5) of the repair layer 16 in the overfill portion removing step S30.

The heating-and-melting step S40 is a step of heating and melting a part of an interface 18, on a surface side of the ceramic coating 10, between the ceramic layer 13 and the repair layer 16. That is, the heating-and-melting step S40 is the step of heating and melting the part of the interface 18, on the surface side of the ceramic coating 10, between the first ceramic layer 13A and the second ceramic layer 16A.

As described above, in partially repairing the ceramic coating 10, it is necessary to ensure adhesiveness between the ceramic layer 13 and the repair layer 16.

As a result of intensive researches by the present inventors, it was found that the adhesiveness between the ceramic layer 13 and the repair layer 16 can be improved while maintaining the heat cycle durability, the thermal conductivity, and the anti-erosion performance of the repair layer 16 equal to those of the ceramic layer 13 by melting the part of the interface 18, on the surface side of the ceramic coating 10, between the ceramic layer 13 and the repair layer 16 by heating the part.

Therefore, according to some embodiments, it is possible to improve the adhesiveness between the ceramic layer 13 and the repair layer 16 while maintaining the heat cycle durability, the thermal conductivity, and the anti-erosion performance of the repair layer 16 equal to those of the ceramic layer 13. Thus, durability of a repair portion of the ceramic coating 10 is improved, making it possible to improve durability of the ceramic coating 10.

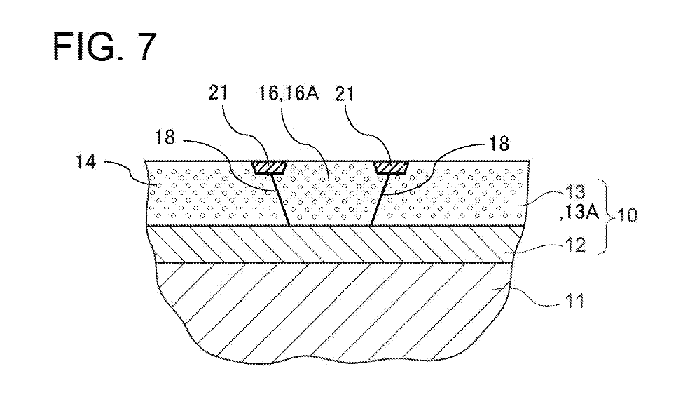

FIG. 7 is a schematic cross-sectional view of the ceramic coating 10 which includes a molten-and-solidified portion 21 formed by heating, melting, and then solidifying a part of the interface 18, on the surface side of the ceramic coating 10, between the ceramic layer 13 and the repair layer 16. The molten-and-solidified portion 21, and the ceramic layer 13 and the unheated and unmelted repair layer 16 have different appearances in a cross-section as depicted in FIG. 7, owing to a difference in the porosity rate and a difference in forming method. Thus, it is easy to visually discriminate the molten-and-solidified portion 21 from a region other than the molten-and-solidified portion 21 and determine that the molten-and-solidified portion2l is a region formed by solidification after melting. For similar reasons, when the ceramic coating 10 is viewed from the surface side, it is also easy to visually discriminate the molten-and-solidified portion 21 from the region other than the molten-and-solidified portion 21 and determine that the molten-and-solidified portion 21 is the region formed by solidification after melting.

The finishing step S50 is a step of smoothing a surface of the molten-and-solidified portion 21 formed in the heating-and-melting step S40. In the finishing step S50, the surface of the molten-and-solidified portion 21 is smoothed by, for example, a grinder.

As described above, the ceramic coating 10 according to some embodiments includes the first ceramic layer 13A and the second ceramic layer 16A adjacent to the first ceramic layer 13A in an in-plane direction of the first ceramic layer 13A. Then, the ceramic coating 10 according to some embodiments includes the molten-and-solidified portion 21 and a molten-and-solidified portion 22 each obtained by melting and solidifying at least the part of the interface 18, on the surface side of the first ceramic layer 13A, between the first ceramic layer 13A and the second ceramic layer 16A.

Therefore, in the ceramic coating 10 according to some embodiments, as described above, it is possible to improve the adhesiveness between the first ceramic layer 13A and the second ceramic layer 16A while maintaining the heat cycle durability, the thermal conductivity, and the anti-erosion performance of the second ceramic layer 16A equal to those of the first ceramic layer 13. Thus, it is possible to improve the durability of the ceramic coating.

(About Heating Method in Heating-and-Melting Step S40) In some embodiments, in the heating-and-melting step S40, any one of a laser, an electronic beam, or a plasma is irradiated to selectively heat and melt the part of the interface 18, on the surface side of the ceramic coating 10, between the ceramic layer 13 and the repair layer 16, thereby forming the molten-and-solidified portion 21.

Thus, it is possible to selectively heat and melt the region to be melted, and to suppress thermal damage to another region.

For instance, described below is an example of laser emission conditions in a case in which heating and melting are performed by laser emission. For instance, an average output is 20 W, an emission speed is 2.4 m/min, and a beam diameter is 0.3 mm. A laser beam may be scanned by using, for example, a six-axis robot, or by using a Galvano lens.

(About Width of Molten-and-Solidified Portion 21)

In the embodiment depicted in FIG. 7, the molten-and-solidified portion 21 has a width of 1 mm or more.

If the width of the molten-and-solidified portion 21 is less than 1 mm, an unheated and unmelted place may be generated in the part of the interface 18 on the surface side of the ceramic layer 13 owing to a positional variation in part heated and melted upon formation of the molten-and-solidified portion 21, for example, a variation in irradiation position of the laser beam or the like. In particular, the interface 18 does not always extend in a direction orthogonal to the surface of the ceramic layer 13 but may extend diagonally with respect to the surface of the ceramic layer 13, that is, in a direction inclined with respect to a thickness direction of the ceramic layer 13. Therefore, if the width of the molten-and-solidified portion 21 is less than 1 mm, a portion except for a very shallow portion on the surface side of the ceramic layer 13 of the interface 18 may fall out of a heating-and-melting range upon formation of the molten-and-solidified portion 21, making it impossible to heat and melt the interface 18 to a desired depth.

In addition, if the width of the molten-and-solidified portion 21 is less than 1 mm, owing to a width variation upon formation of the molten-and-solidified portion 21, the width of the molten-and-solidified portion 21 may become extremely small in a particular region, generating a portion where the adhesiveness between the ceramic layer 13 and the repair layer 16 is insufficient.

As described above, if the width of the molten-and-solidified portion 21 is less than 1 mm, the portion where the adhesiveness between the ceramic layer 13 and the repair layer 16 is insufficient may be generated. Thus, it is desirable that the width of the molten-and-solidified portion 21 is 1 mm or more.

In this regard, in some embodiments, since the width of the molten-and-solidified portion 21 is 1 mm or more, it is possible to ensure the adhesiveness between the ceramic layer 13 and the repair layer 16.

(About Heating and Melting of Superficial Portion of Repair Layer 16)

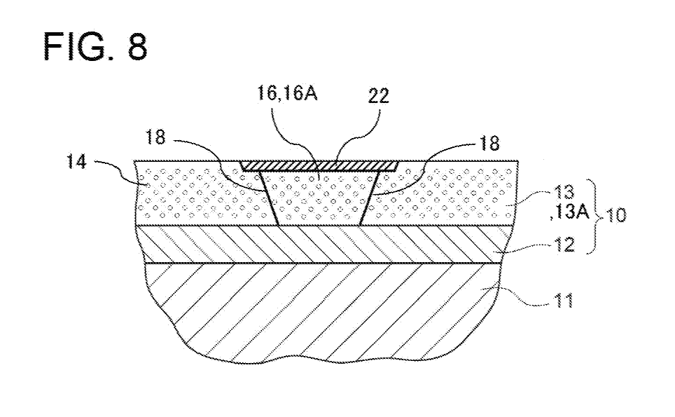

In the embodiment depicted in FIG. 7, the molten-and-solidified portion 21 is formed by heating and melting only a part of the surface of the ceramic layer 13 and the repair layer 16 in contact via the interface 18. However, as the embodiment depicted in FIG. 8, in the heating-and-melting step S40, a superficial portion of the repair layer 16 may be heated and melted in addition to the part on the surface side of the interface 18. That is, in the embodiment depicted in FIG. 8, in the heating-and-melting step S40, any one of the laser, the electronic beam, or the plasma is irradiated to selectively heat and melt a superficial region of the ceramic coating 10 including the part of the interfacel8, on the surface side of the ceramic coating 10, between the ceramic layer 13 and the repair layer 16, thereby forming the molten-and-solidified portion 22.

FIG. 8 is a schematic cross-sectional view of the ceramic coating 10 which includes the molten-and-solidified portion 22 formed by heating, melting, and then solidifying the superficial portion of the repair layer 16 in addition to the part of the interface 18 on the surface side. As described above, the molten-and-solidified portion 22 depicted in FIG. 8 is in a state where the superficial portion of the repair layer 16 is melted and solidified in addition to the part of the interface 18 on the surface side.

Similarly to the molten-and-solidified portion 21 depicted in FIG. 7, it is easy to visually discriminate the molten-and-solidified portion 22 depicted in FIG. 8 from a region other than the molten-and-solidified portion 22 and determine that the molten-and-solidified portion 22 is a region formed by solidification after melting.

A portion which is heated, melted, and then solidified in the ceramic coating 10 has a hardness higher than that of an unheated and unmelted portion. In this regard, in the embodiment depicted in FIG. 8, since the hardness of the superficial portion of the repair layer 16 after being heated and melted is high compared to a case in which the portion is neither heated nor melted, it is possible to improve the anti-erosion performance of the repair layer 16. Therefore, if the repair section 15 needs repairing owing to erosion, the superficial portion of the repair layer 16 is heated and melted in addition to the part of the interface 18 on the surface side, making it possible to improve the anti-erosion performance of the repair layer 16 with the molten-and-solidified portion 22 being formed on the surface side and to improve the durability of the ceramic coating 10 after repair.

(About Depths of Molten-and-Solidified Portions 21 and 22)

In some embodiments, the molten-and-solidified portions 21 and 22 have depths of 5 micrometers or more and 100 micrometers or less.

If the depths of the molten-and-solidified portions 21 and 22 are less than 5 micrometers, owing to a depth variation upon formation of the molten-and-solidified portions 21 and 22, the depths may become extremely shallow in a particular region. For instance, if the depths of the molten-and-solidified portions 21 and 22 become extremely shallow in the particular region in the vicinity of the interface 18, the portion where the adhesiveness between the ceramic layer 13 and the repair layer 16 is insufficient may be generated. In addition, for example, in the embodiment depicted in FIG. 8, if the depth of the molten-and-solidified portion 22 becomes extremely shallow in the particular region, the anti-erosion performance may degrade. Thus, it is desirable that the depths of the molten-and-solidified portions 21 and 22 are 5 micrometers or more. Further, if the depths of the molten-and-solidified portions 21 and 22 exceed 100 μm, the heat cycle durability of the molten-and-solidified portions 21 and 22 may decrease. Thus, it is desirable that the depths of the molten-and-solidified portions 21 and 22 are 100 μm or less.

In this regard, in some embodiments, since the depths of the molten-and-solidified portions 21 and 22 are 5 micrometers or more and 100 micrometers or less, it is possible to endure the heat cycle durability of the molten-and-solidified portion 21 while ensuring the adhesiveness between the ceramic layer 13 and the repair layer 16, and the anti-erosion performance.

(About Porosity Rate of Repair Layer 16)

In some embodiments, the repair layer 16 may has a porosity rate higher than that of the ceramic layer 13.

In general, in the ceramic coating 10, the thermal conductivity decreases as the porosity rate increases. Therefore, if the porosity rate of the repair layer 16 is made higher than that of the ceramic layer 13, it is possible to make the thermal conductivity of the repair layer 16 lower than that of the ceramic layer 13. Therefore, for example, if the repair section 15 needs an improvement of thermal barrier performance upon being repaired, it is possible to improve the thermal barrier performance by making the porosity rate of the repair layer 16 higher than that of the ceramic layer 13.

Making the porosity rate of the repair layer 16 higher than that of the ceramic layer 13 is particularly useful in a case in which the superficial portion of the repair layer 16 is heated and melted as the embodiment depicted in FIG. 8. That is, if the superficial portion of the repair layer 16 is heated and melted as the embodiment depicted in FIG. 8, the pores in the repair layer 16 disappear upon melting, increasing the thermal conductivity of the superficial portion of the repair layer 16 after solidification, that is, the molten-and-solidified portion 22.

In this regard, if the porosity rate of the repair layer 16 is made higher than that of the ceramic layer 13, it is possible to make a thermal conductivity in an unheated and unmelted part of the repair layer 16 other than the molten-and-solidified portion 22 lower than that of the ceramic layer 13. Accordingly, it is possible to suppress an increase in thermal conductivity of the repair portion of the ceramic coating 10.

Further, in some embodiments, in the repair layer forming step S20, the ceramic layer 16 may be formed to have a porosity rate of 10% or more and 30% or less.

For instance, when the ceramic layer 13 is formed by thermal spray or the like, a general lower limit value of the porosity rate of the ceramic layer 13 is about several %. If the repair layer 16 is formed to have the porosity rate of 10% or more, it is possible to expect that the thermal conductivity of the repair layer 16 becomes lower than that of the ceramic layer 13. Therefore, for example, if the improvement of thermal barrier performance is required because the repair section 15 is in a severer temperature environment than a region other than the repair section, it is possible to expect that the thermal barrier performance of the repair layer 16 after repair improves as compared with before repair by setting the porosity rate of the repair layer 16 at 10% or more and 30% or less. As described above, improving the thermal barrier performance of the repair layer 16 after repair is particularly useful in the case in which the superficial portion of the repair layer 16 is heated and melted as the embodiment depicted in FIG. 8.

On the other hand, if the porosity rate of the repair layer 16 increases, the adhesiveness with the ceramic layer 13 tends to decrease. Thus, if the porosity rate of the repair layer 16 exceeds 30%, the adhesiveness with the first ceramic layer may be insufficient. In this regard, it is possible to ensure the thermal barrier performance of the repair layer 16 while ensuring the adhesiveness with the ceramic layer 13 by setting the porosity rate of the repair layer 16 at 10% or more and 30% or less.

(Turbine Member and Gas Turbine)

The ceramic coating 10 according to some embodiments described above is suitably applicable to rotor blades and stator vanes of an industrial gas turbine, or high-temperature components such as combustor baskets and combustor transition pieces. Further, the ceramic coating 10 can be applied to not only an industrial gas turbine but also a thermal barrier coating film of a high-temperature component of an engine of an automobile or a jet, for instance. It is possible to obtain gas turbine blades and high-temperature components having high durability by providing the above members with the ceramic coating 10 according to some embodiments described above.

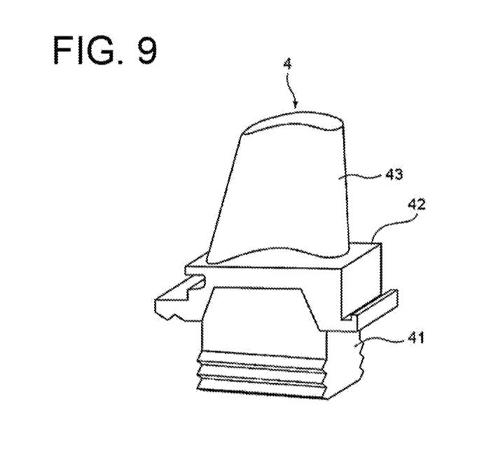

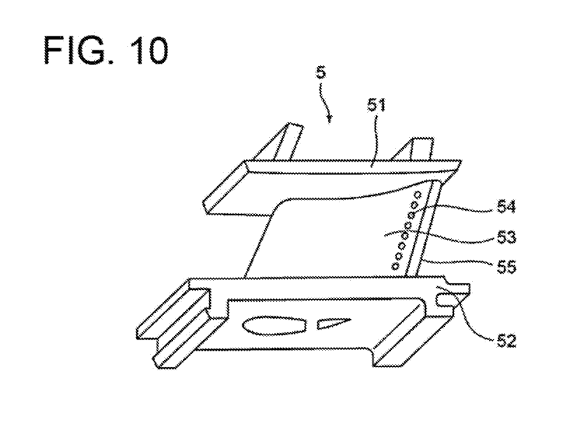

FIGS. 9 and 10 are perspective views each showing a configuration example of a turbine blade being a turbine member to which the ceramic coating 10 according to some embodiments described above can be applied. A gas turbine rotor blade 4 depicted in FIG. 9 includes a dovetail 41 to be fixed to a disc side, a platform 42, a blade portion 43, and the like. Further, a gas turbine stator vane 5 depicted in FIG. 10 includes an inner shroud 51, an outer shroud 52, a blade portion 53, and the like. A seal-fin cooling hole 54 and a slit 55 are formed in the blade portion 53, for instance.

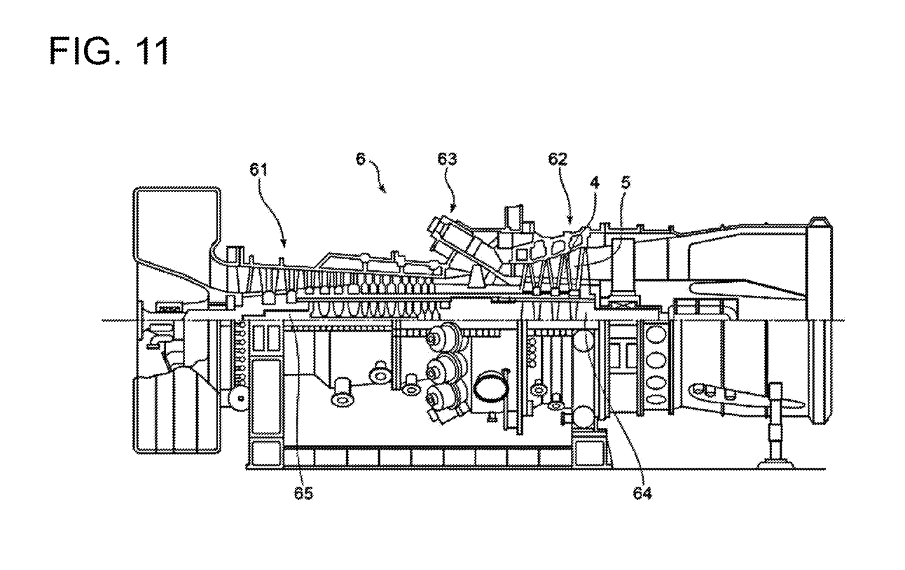

Next, a gas turbine to which the turbine blades 4 and 5 depicted in FIGS. 9 and 10 can be applied will be described below with reference to FIG. 11. FIG. 11 is a schematic diagram of a partial cross-sectional structure of a gas turbine according to an embodiment. A gas turbine 6 includes a compressor 61 and a turbine 62 coupled directly to one another. The compressor 61 is configured as an axial-flow compressor, for instance, and takes in atmosphere or a predetermined gas from an intake port as a working fluid and increases the pressure. A combustor 63 is connected to an outlet of the compressor 61, and a working fluid discharged from the compressor 61 is heated to a predetermined turbine inlet temperature by the combustor 63. Further, the working fluid having its temperature increased to a predetermined temperature is supplied to the turbine 62. As depicted in FIG. 11, inside a casing of the turbine 62, a plurality of stages of gas turbine stator vanes 5 described above are provided. Further, the above-described gas turbine rotor blades 4 are mounted to a main shaft 64 so as to form a pair of stages with each of the stator vanes 5. An end of the main shaft 64 is connected to a rotational shaft 65 of the compressor 61, and the other end of the main shaft 64 is connected to a rotational shaft of a generator (not depicted).

With the above configuration, when a working fluid having a high temperature and a high pressure is supplied into the casing of the turbine 62 from the combustor 63, the working fluid expands in the casing and thereby the main shaft 64 rotates, and a non-depicted generator connected to the gas turbine 6 is driven. That is, the pressure is reduced by the stator vanes 5 fixed to the casing, and the kinetic energy generated thereby is converted into rotational torque via the rotor blades 4 mounted to the main shaft 64. Further, the generated rotation torque is transmitted to the main shaft 64, and the generator is driven.

Generally, heat-resistant alloy (e.g. IN738LC; commercial alloy material offered by Inco Limited) is used as a material of gas turbine rotor blades, and similarly, another heat-resistant alloy (e.g. IN939; commercial alloy material offered by Inco Limited) is used as a material of gas turbine stator vanes. That is, as a material of a turbine blade, a heat-resistant alloy that can be used as the base material 11 in the ceramic coating 10 according to some embodiments described above is used. Thus, it is possible to obtain a turbine blade having a high thermal barrier effect and durability by applying the above ceramic coating 10 according to some embodiments described above to the turbine blades. Thus, it is possible to use the turbine blades in an environment with a higher temperature, and obtain long-life turbine blades. Further, if the ceramic coating 10 is applicable under an environment with a higher temperature, it means that the temperature of the working fluid can be increased, and thus it is also possible to improve the gas turbine efficiency.

As described above, the turbine blades 4 and 5 being the turbine members according to some embodiments include the ceramic coating 10 according to some embodiments described above. Thus, it is possible to improve the adhesiveness between the ceramic layer 13 and the repair layer 16 while maintaining the heat cycle durability, the thermal conductivity, and the anti-erosion performance of the repair layer 16 equal to those of the ceramic layer 13, making it possible to improve durability of the turbine members.

Further, the gas turbine 6 according to some embodiments includes the turbine blades 4, 5 being the above turbine members, and thus it is possible to improve the durability of turbine members in the gas turbine 6.

Embodiments of the present invention were described in detail above, but the present invention is not limited thereto, and various amendments and modifications may be implemented.

For instance, in some embodiments described above, the second ceramic layer 16A is the repair layer 16 and is the layer formed in order to repair the ceramic coating 10. However, the present invention is not limited to this. For instance, the present invention may be applied when forming the ceramic coating 10 on the base material 11. In this case, the second ceramic layer 16A is not the repair layer 16 formed by repair afterwards but a layer existing from the time of formation of the ceramic coating 10.

1. A method of repairing a ceramic coating, comprising:
forming a second ceramic layer by thermally spraying ceramic spray particles to a repair section of the ceramic coating in which a first ceramic layer is formed; and
melting a part of an interface, on a surface side of the ceramic coating, between the first ceramic layer and the second ceramic layer by heating the part.

2. The method of repairing the ceramic coating according to claim 1,
wherein, in the melting of the part, a superficial portion of the second ceramic layer is heated and melted in addition to the part of the interface.

3. The method of repairing the ceramic coating according to claim 1,
wherein the second ceramic layer has a higher porosity rate than the first ceramic layer.

4. The method of repairing the ceramic coating according to claim 1,
wherein, in the forming of the second ceramic layer, the second ceramic layer is formed to have a porosity rate of 10% or more and 30% or less.

5. The method of repairing the ceramic coating according to claim 1,
wherein, in the melting of the part, any one of a laser, an electronic beam, or a plasma is irradiated to selectively heat and melt a superficial region of the ceramic coating including the part of the interface.

6. The method of repairing the ceramic coating according to claim 1,
wherein, in the forming of the second ceramic layer, the second ceramic layer is formed adjacent to the first ceramic layer in an in-plane direction of the first ceramic layer.

7. The method of repairing the ceramic coating according to claim 1,
wherein, in the forming of the second ceramic layer, the second ceramic layer is formed with the interface extending in a direction inclined with respect to a thickness direction of the first ceramic layer.

8. The method of repairing the ceramic coating according to claim 1,
wherein, in the forming of the second ceramic layer, the second ceramic layer is formed by thermally spraying the ceramic spray particles of the same material as a material of the first ceramic layer to the repair section.

9. The method of repairing the ceramic coating according to claim 1,
wherein the first ceramic layer is formed by thermal spray, and
wherein, in the forming of the second ceramic layer, the second ceramic layer is formed by thermally spraying the ceramic spray particles to the repair section on the same spray condition as a spray condition upon formation of the first ceramic layer.

10. The method of repairing the ceramic coating according to claim 1, further comprising treating a surface of the repair section.

11. The method of repairing the ceramic coating according to claim 1,
further comprising removing an overfill portion of the second ceramic layer formed in the forming of the second ceramic layer.

12. The method of repairing the ceramic coating according to claim 1,
further comprising smoothing a surface of a molten-and-solidified portion formed in the melting of the portion.

13. A ceramic coating comprising:
a first ceramic layer;
a second ceramic layer adjacent to the first ceramic layer in an in-plane direction of the first ceramic layer; and
a molten-and-solidified portion obtained by melting and solidifying at least a part of an interface, on a surface side of the first ceramic layer, between the first ceramic layer and the second ceramic layer.

14. The ceramic coating according to claim 13,
wherein the molten-and-solidified portion has a depth of 5 micrometers or more and 100 micrometers or less.

15. The ceramic coating according to claim 13,
wherein the molten-and-solidified portion has a width of 1 mm or more.

16. The ceramic coating according to claim 13,
wherein the molten-and-solidified portion is in a state where a superficial portion of the second ceramic layer is melted and solidified in addition to the part of the interface.

17. The ceramic coating according to claim 13,
wherein the second ceramic layer has a porosity rate of 10% or more and 30% or less.

18. A turbine member comprising the ceramic coating according to claim 13.

19. A gas turbine comprising the turbine member according to claim 18.
